(19) United States
(12) Patent Application Publication
(10) Pub. No.: US 2013/0230995 A1
(43) Pub. Date: Sep. 5, 2013

(54) ELECTRICAL CONNECTOR HEADER FOR AN LED-BASED LIGHT

(71) Applicant: ILUMISYS, INC., Troy, MI (US)

(72) Inventors: John Ivey, Farmington Hills, MI (US); Ryan MEGANCK, Troy, MI (US); Hoan NGO, Sterling Heights, MI (US); James AMRINE, Ann Arbor, MI (US)

(73) Assignee: ILUMISYS, INC., Troy, MI (US)

(21) Appl. No.: 13/782,763

(22) Filed: Mar. 1, 2013

Related U.S. Application Data
(60) Provisional application No. 61/605,987, filed on Mar. 2, 2012.

(51) Int. Cl. H01R 12/71; H01R 43/20

(52) U.S. Cl. CPC H01R 12/71; H01R 43/20
USPC 439/226; 29/874

(57) ABSTRACT

An LED-based light configured for replacing a conventional fluorescent light in a fluorescent light fixture comprises: an LED circuit board including at least one LED; a power supply circuit board configured to supply power to the at least one LED; an end cap carrying at least one pin configured for connection to the fixture; a pin connector header including a first body retentively supporting at least one pin connecting lead and configured to engage the power supply circuit board such that the pin connecting lead is positioned to electrically connect the power supply circuit board and the pin; and a circuit connector header including a second body retentively supporting at least one circuit connecting lead and configured to engage the power supply circuit board such that the circuit connecting lead is positioned to electrically connect the power supply circuit board and the LED circuit board.

### CROSS-REFERENCE TO RELATED APPLICATION

This application is a claims priority from U.S. Provisional Application Ser. No. 61/605,987 filed Mar. 2, 2012, which is hereby incorporated by reference in its entirety.

### TECHNICAL FIELD

The embodiments disclosed herein relate in general to a light emitting diode (LED)-based light for replacing a conventional light in a standard light fixture, and in particular to components and processes for making electrical connections between electrical assemblies in an LED-based light.

### BACKGROUND

Fluorescent lights are widely used in a variety of locations, such as schools and office buildings. Although conventional fluorescent lights have certain advantages over, for example, incandescent lights, they also pose certain disadvantages including, inter alia, disposal problems due to the presence of toxic materials within the light.

LED-based lights designed as one-for-one replacements for fluorescent lights have appeared in recent years. These LED-based lights can include a number of electrical assemblies, such as electrical connectors and various circuit boards. Electrical connections are often required between the electrical assemblies in order to permit conveyance of power between them. During manufacture of an LED-based light, these electrical connections may be made by landing wires between the electrical assemblies. However, wires are typically flexible and may be hard to grasp. Further, undesirable memory may be generated within a wire due to spooling, which causes inconsistencies in the curvature of a given length of wire. These properties, for example, can make it difficult to position and maintain typical wires in a desired orientation and spacing with respect to the electrical assemblies while making the electrical connections.

Manufacturers of LED-based lights, and in particular manufactures wanting to automate the assembly of LED-based lights, may therefore desire improvements upon the components and processes typically used for making electrical connections between the electrical assemblies.

### SUMMARY

Disclosed herein are embodiments of LED-based lights including connector headers and method for assembling components of LED-based lights using connector headers.

In one aspect, an LED-based light configured for replacing a conventional fluorescent light in a fluorescent light fixture comprises: an LED circuit board including at least one LED; a power supply circuit board configured to supply power to the at least one LED; an end cap carrying at least one pin configured for connection to the fixture; a pin connector header, the pin connector header including a first body retentively supporting at least one pin connecting lead and configured to engage the power supply circuit board such that the pin connecting lead is positioned to electrically connect the power supply circuit board and the pin; and a circuit connector header, the circuit connector header including a second body retentively supporting at least one circuit connecting lead and configured to engage the power supply circuit board such that the circuit connecting lead is positioned to electrically connect the power supply circuit board and the LED circuit board.

In another aspect, an LED-based light configured for replacing a conventional fluorescent light in a fluorescent light fixture comprises: an LED circuit board including at least one LED; a power supply circuit board configured to supply power to the at least one LED; an end cap carrying at least one pin configured for connection to the fixture; and a connector header, the connector header including a body retentively supporting at least one lead having a first contacting portion and a second contacting portion and configured to engage the power supply circuit board such that the first contacting portion of the lead is positioned within a pad of the power supply circuit board and the second contacting portion of the lead is positioned within one of: a pad of the LED circuit board to electrically connect the power supply circuit board and the LED circuit board, and a pin cavity defined by the pin to electrically connect the power supply circuit board and the pin.

In yet another aspect, a method of assembling components of an LED-based light configured for replacing a conventional fluorescent light in a fluorescent light fixture, the components including at least an LED circuit board including at least one LED, a power supply circuit board configured to supply power to the at least one LED and an end cap carrying at least one pin configured for connection to the fixture comprises: engaging the power supply circuit board with a connector header including a body retentively supporting at least one lead and having a first contacting portion and a second contacting portion, wherein the engagement positions the first portion within a pad of the power supply circuit board and arranges the second contacting portion at a predetermined position; and positioning one of the LED circuit board and the pin based on the predetermined position of the second contacting portion.

These and other aspects will be described in additional detail below.

### BRIEF DESCRIPTION OF THE DRAWINGS

The various features, advantages and other uses of the present apparatus will become more apparent by referring to the following detailed description and drawings in which:

FIG. 1 is a partial perspective view of an example of an LED-based light;

FIG. 2 is a partial perspective view of examples of electrical assemblies housed by the LED-based light of FIG. 1;

FIG. 3 is a partial cut away elevation view of the LED-based light of FIG. 1 taken along the line 3-3 and showing the electrical assemblies of FIG. 2 electrically connected by an exemplary circuit connector header and an exemplary pin connector header;

FIG. 4 is a perspective view of the exemplary circuit connector header of FIG. 3;

FIG. 5 is a perspective view of the exemplary pin connector header of FIG. 3;

FIG. 6 is a partial perspective view showing further details of the electrical connections between the electrical assemblies of FIG. 2 by the exemplary circuit connector header of FIG. 4 and the exemplary pin connector header of FIG. 5; and

FIGS. 7 and 8 are flowcharts depicting operations for making electrical connections between the electrical assemblies of FIG. 2 using the exemplary circuit connector header of FIG. 4 the exemplary pin connector header of FIG. 5, respectively.

### DETAILED DESCRIPTION

Disclosed herein are embodiments of electrical connector headers that can simplify the process of making electrical connections between the electrical assemblies of an LED-based light. The electrical connector headers can be manipulated by automated equipment in order to facilitate automated assembly of LED-based lights. Although the disclosed embodiments of electrical connector headers offer particular advantages with respect to automated assembly of LED-based lights, it will be understood that the electrical connector headers may be advantageously applied in manual assembly processes as well.

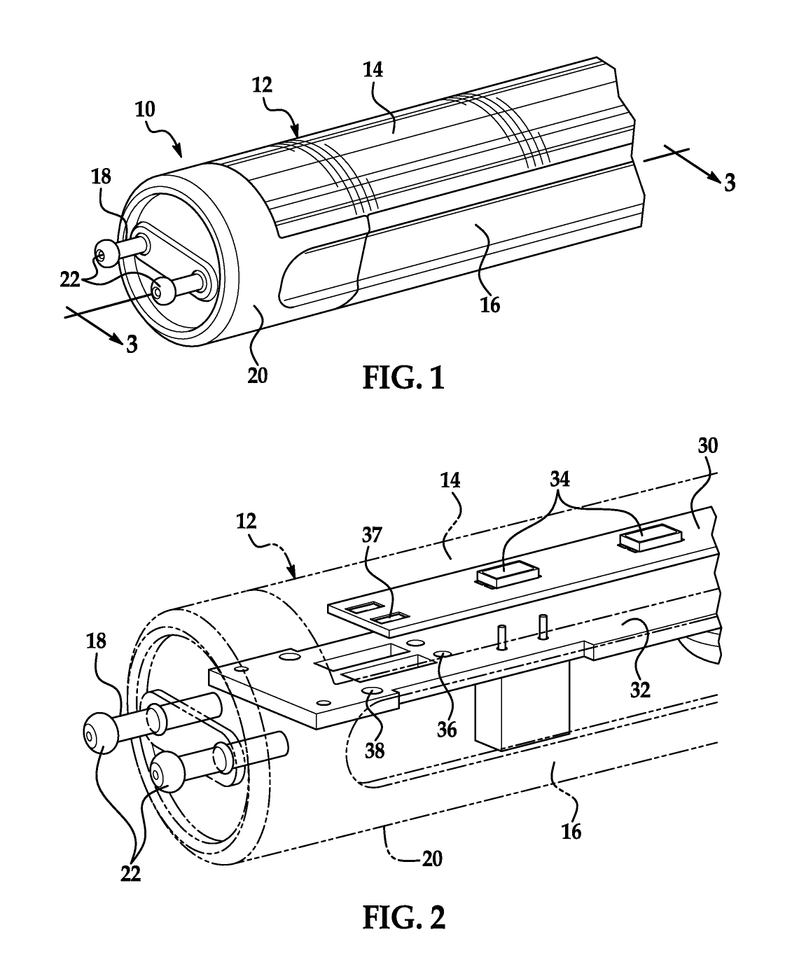

FIG. 1 illustrates an LED-based light 10 for replacing a conventional light in a standard light fixture (not shown). The light fixture can be designed to accept conventional fluorescent lights, such as T5, T8 or T12 fluorescent tube lights, or can be designed to accept other standard lights, such as incandescent bulbs. The light fixture could alternatively be designed to accept non-standard lights, such as lights installed by an electrician. The fixture can connect to a power source, and can optionally include a ballast connected between the power source and LED-based light 10.

In some implementations, the LED-based light 10 includes a housing 12 at least partially defined by a high dielectric light transmitting lens 14. The lens 14 can be made from polycarbonate, acrylic, glass or other light transmitting material (i.e., the lens 14 can be transparent or translucent). The term “lens” as used herein means a light transmitting structure, and not necessarily a structure for concentrating or diverging light.

The LED-based light 10 can include features for uniformly distributing light to an environment to be illuminated in order to replicate the uniform light distribution of a conventional fluorescent light. For example, the lens 14 can be manufactured to include light diffracting structures, such as ridges, dots, bumps, dimples or other uneven surfaces formed on an interior or exterior of the lens 14. The light diffracting structures can be formed integrally with the lens 14, for example, by molding or extruding, or the structures can be formed in a separate manufacturing step such as surface roughening. In addition to or as an alternative to light diffracting structures, a light diffracting film can be applied to the exterior of the lens 14 or placed in the housing 12, or, the material from which the lens 14 is formed can include light refracting particles. For example, the lens 14 can be made from a composite, such as polycarbonate, with particles of a light refracting material interspersed in the polycarbonate. In other embodiments, the LED-based light 10 may not include any light diffracting structures or film.

The illustrated example of a housing 12 can be formed by attaching multiple individual parts, not all of which need be light transmitting. For example, the housing 12 can be formed in part by attaching the lens 14 to an opaque lower portion 16. Alternatively, the housing 12 can include a light transmitting tube at least partially defined by the lens 14. The housing 12 can additionally include other components, such as one or more highly thermally conductive structures for enhancing heat dissipation. While the illustrated housing 12 is cylindrical, a housing having a square, triangular, polygonal, or other cross sectional shape can alternatively be used. Similarly, while the illustrated housing 12 is linear, housings having an alternative shape, e.g., a U-shape or a circular shape can alternatively be used. The LED-based light 10 can have any suitable length. For example, the LED-based light 10 may be approximately 48″ long, and the housing 12 can have a 0.625″, 1.0″ or 1.5″ diameter for engagement with a common standard fluorescent light fixture.

The LED-based light 10 can include an electrical connector 18 positioned at an end of the housing 12. In the illustrated example, the electrical connector 18 is a bi-pin connector carried by an end cap 20. A pair of end caps 20 can be attached at opposing longitudinal ends of the housing 12 for physically connecting the LED-based light 10 to a standard fluorescent light fixture. The end caps 20 can be the sole physical connection between the LED-based light 10 and the fixture. At least one of the end caps 20 can additionally electrically connect the LED-based light 10 to the fixture to provide power to the LED-based light 10. Each end cap 20 can include two pins 22, although two of the total four pins can be “dummy pins” that provide physical but not electrical connection to the fixture. Bi-pin electrical connector 18 is compatible with many standard fluorescent fixtures, although other types of electrical connectors can be used, such as single pin connector or screw type connector.

As shown with additional reference to FIG. 2, the LED-based light 10 can include a number of electrical assemblies, such as the electrical connector 18 and one or more circuit boards 30 and 32 supported within the housing 12. The circuit board 30 can be an LED circuit board having at least one LED circuit. The LED circuit board 30 can include at least one LED 34, a plurality of series-connected or parallel-connected LEDs 34, an array of LEDs 34 or any other arrangement of LEDs 34. Each of the illustrated LEDs 34 can include a single diode or multiple diodes, such as a package of diodes producing light that appears to an ordinary observer as coming from a single source. The LEDs 34 can be surface-mount devices of a type available from Nichia, although other types of LEDs can alternatively be used. For example, the LED-based light 10 can include high-brightness semiconductor LEDs, organic light emitting diodes (OLEDs), semiconductor dies that produce light in response to current, light emitting polymers, electro-luminescent strips (EL) or the like.

The LEDs 34 can emit white light. However, LEDs that emit blue light, ultra-violet light or other wavelengths of light can be used in place of or in combination with white light emitting LEDs 34. The number, spacing and orientation of the LEDs 34 can be a function of a length of the LED-based light 10, a desired lumen output of the LED-based light 10, the wattage of the LEDs 34 and/or the viewing angle of the LEDs 34. For a 48″ LED-based light 10, the number of LEDs 34 may vary from about thirty to sixty such that the LED-based light 10 outputs approximately 3,000 lumens. However, a different number of LEDs 34 can alternatively be used, and the LED-based light 10 can output any other amount of lumens. The LEDs 34 can be evenly spaced along the LED circuit board 30 and arranged on the LED circuit board 30 to substantially fill a space along a length of the lens 14 between end caps 20 positioned at opposing longitudinal ends of the housing 12. Alternatively, single or multiple LEDs 34 can be located at one or both ends of the LED-based light 10. The LEDs 34 can be arranged in a single longitudinally extending row along a central portion of the LED circuit board 30, as shown in FIG. 2, or can be arranged in a plurality of rows or arranged in groups. The spacing of the LEDs 34 can be determined based on, for example, the light distribution of each LED 34 and the number of LEDs 34.

The circuit board 32 can be a power supply circuit board. The power supply circuit board 32 is positioned within the housing adjacent the electrical connector 18 and has power supply circuitry configured to condition an input power received from, for example, the fixture through the electrical connector 18, to a power usable by and suitable for the LEDs 34. In some implementations, the power supply circuit board 32 can include one or more of an inrush protection circuit, a surge suppressor circuit, a noise filter circuit, a rectifier circuit, a main filter circuit, a current regulator circuit and a shunt voltage regulator circuit. The power supply circuit board 32 can be suitably designed to receive a wide range of currents and/or voltages from a power source and convert them to a power usable by the LEDs 34.

As shown, the LED circuit board 30 and the power support circuit board 32 are vertically opposed and spaced with respect to one another within the housing 12. However, it will be understood that the LED circuit board 30 and/or the power support circuit board 32 could be alternatively arranged within the housing 12, and that the LED circuit board 30 and the power support circuit board 32 could be alternatively spaced with respect to one another. Further, although the LED circuit board 30 and the power supply circuit board 32 are shown as separate components, the power supply circuitry and the LED circuit could alternatively be included in a single circuit board.

The LED circuit board 30 and the power supply circuit board 32 are illustrated as elongate printed circuit boards that have electrical tracks at least partially defining the respective included circuits, which can be exposed by electrically conductive pads 37, and 36 and 38, respectively, as described in greater detail below. The LED circuit board 30 and the power supply circuit board 32 can extend a length or a partial length of the housing 12, and the LED circuit board 30 can have a length different from a length of the power supply circuit board 32. Multiple circuit board sections can be joined by bridge connectors to create the LED circuit board 30 and/or power supply circuit board 32. The LED circuit board 30 and the power supply circuit board 32 can be supported within the housing 12 through slidable engagement with a part of the housing 12, such as the end cap 20 and/or lower portion 16, though the circuit boards 30 and 32 can alternatively be clipped, adhered, snap- or friction-fit, screwed or otherwise connected to the housing 12. Also, other types of circuit boards may be used, such as a metal core circuit board. Or, instead of the LED circuit board 30 and the power supply circuit board 32, other types of electrical connections (e.g., wires) can be used to electrically connect the LEDs 34 to a power source.

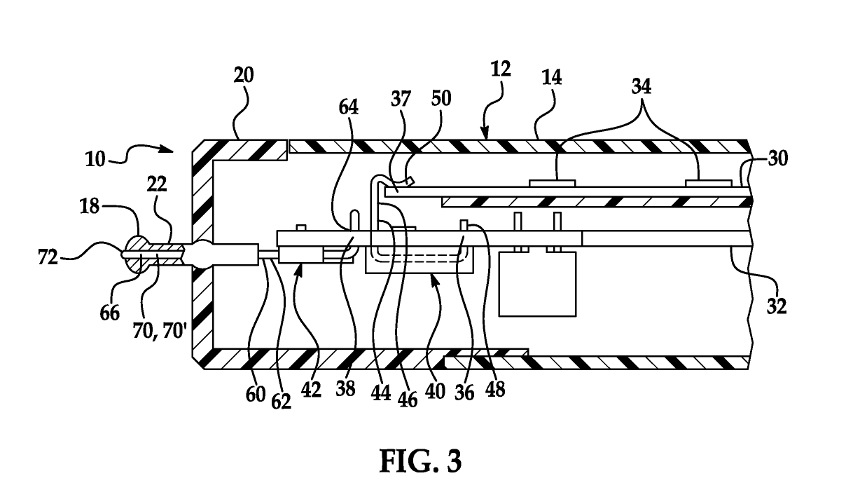

The LED-based light 10 may require a number of electrical connections to convey power between the various illustrated spatially distributed electrical assemblies that can be included in the LED-based light 10, such as the LED circuit board 30, the power supply circuit board 32 and the electrical connector 18. During assembly of the LED-based light 10, these connections can be made using a circuit connector header 40 and a pin connector header 42, as shown in FIG. 3. As shown, the circuit connector header 40 is arranged to electrically couple the LED circuit board 30 to the power supply circuit board 32, and the pin connector header 42 is arranged to electrically couple the power supply circuit board 32 to a fixture.

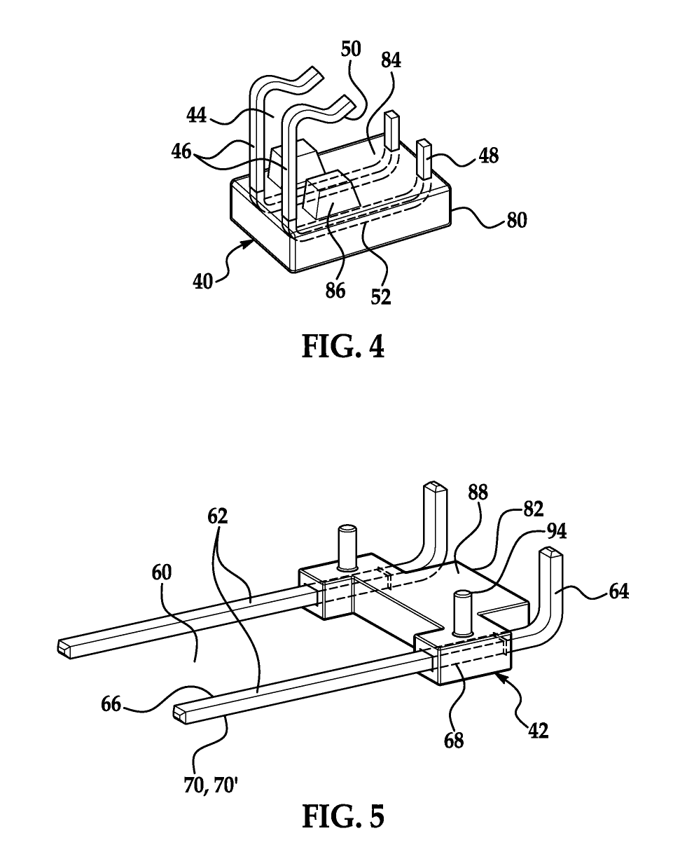

As shown with additional reference to FIG. 4, the circuit connector header 40 includes at least one contact element 44 configured to electrically couple the LED circuit included in the LED circuit board 30 to the power supply circuitry included in the power supply circuit board 32. The contact element 44 is illustrated as a pair of continuous electrically conductive circuit connecting leads 46, although the contact element 44 can alternatively be any number of circuit connecting leads 46, such as a single circuit connecting lead 46. The circuit connecting leads 46 may have a configuration differing from that specifically shown. For instance, the circuit connecting leads 46 could be or include one or more blade shaped components. The contact element 44 can have at least one power supply circuit board contacting portion 48 and at least one LED circuit board contacting portion 50. As shown, a pair of power supply circuit board contacting portions 48 is located at respective first terminal ends of the circuit connecting leads 46, and a pair of LED circuit board contacting portions 50 is located at respective second terminal ends of the circuit connecting leads 46 opposite the first terminal ends. In one embodiment, and as illustrated in FIG. 4, the power supply circuit board contacting portion 48 and the LED circuit board contacting portion 50 can be in electrically conductive communication through an intermediate portion 52 formed continuously with the first and second terminal ends of the lead 46.

Each power supply circuit board contacting portion 48 can be positioned within the housing 12 to electrically connect to a part of the power supply circuit, for example a conditioned power output pad 36 included in the power supply circuit board 32. The conditioned power output pad 36 is shown as a through-hole pad defined by the power supply circuit board 32, although the conditioned power output pad 36 could alternatively be a surface mount pad, for example. The power supply circuit board contacting portion 48 can be inserted into the conditioned power output pad 36 and secured by methods known to those skilled in the art, such as soldering, so that power can be conveyed from the power supply circuitry included in the power supply circuit board 32 to the contact element 44. Similarly, each LED circuit board contacting portion 50 can be positioned within the housing 12 to contact a part of the LED circuit, for example a conditioned power receiving pad 37 included in the LED circuit board 30. The conditioned power receiving pad 37 is shown as a surface mount pad, although the conditioned power receiving pad 37 could alternatively be a through-hole pad, for example. The LED circuit board contacting portion 50 can be placed into the conditioned power receiving pad 37 and secured, for example, through a spring contact force applied by an arcuate portion of the lead 46. The spring contact force can urge the LED circuit board contacting portion 50 into an electrically conductive relation with the conditioned power receiving pad 37. The LED circuit board contacting portion 50 can additionally or alternatively be secured by other methods known to those skilled in the art, such as soldering. Once secured, power can be conveyed from the contact element 44 to the LED circuit included in the LED circuit board 32. With both the power supply circuit board contacting portion 48 and the LED circuit board contacting portion 50 secured, the power supply circuit and the LED circuit are electrically coupled through the contact element 44, such that a power usable by the LEDs 34 can be supplied from the power supply circuitry to the LED circuit.

As shown in FIGS. 3 and 5, the pin connector header 42 includes at least one contact element 60 configured to electrically couple the power supply circuitry included in the power supply circuit board 32 to a fixture. The contact element 60 is illustrated as a pair of continuous electrically conductive pin connecting leads 62, although the contact element 60 can alternatively be any number of pin connecting leads 62, such as a single lead 62. The pin connecting leads 62 may have a configuration differing from that specifically shown. For instance, the pin connecting leads 62 could be or include one or more blade shaped components and/or could include one or more portions shaped for compatibility with a standard light fixture, as explained below. The contact element 60 can have at least one power supply circuit board contacting portion 64 and at least one input power conducting portion 66. As shown, a pair of power supply circuit board contacting portions 64 is located at respective first terminal ends of the pin connecting leads 62, and a pair of input power conducting portions 66 is located at respective second terminal ends of the pin connecting leads 62 opposite the first terminal ends. In one embodiment, and as illustrated in FIG. 5, the power supply circuit board contacting portion 64 and input power conducting portion 66 can be in electrically conductive communication through an intermediate portion 68 formed continuously with the first and second terminal ends of the lead 62.

Each power supply circuit board contacting portion 64 can be positioned within the housing 12 to electrically connect to a part of the power supply circuit, for example a input power receiving pad 38 included in the power supply circuit board 32. The input power receiving pad 38 is shown as a through-hole pad defined by the power supply circuit board 32, although the input power receiving pad 38 could alternatively be a surface mount pad, for example. The power supply circuit board contacting portion 64 can be inserted into the input power receiving pad 38 and secured by methods known to those skilled in the art, such as soldering, so that power can be conveyed from the power supply circuitry included in the power supply circuit board 32 to the contact element 60.

The input power conducting portions 66 can have a pin contacting portion 70 configured for electrical connection with an electrical connector 18, such as the illustrated bi-pin connector having a pair of pins 22. The pin contacting portion 70 can be positioned within the housing 12 in electrically conductive contact with one or both of the pins 22. The pin contacting portion 70 and a pin 22 can have respective complementary surfaces configured for electrical conduction when placed into contact with one another. As illustrated, a pin 22 can define a cavity, and the pin contacting portion 70 can be axially aligned with the pin cavity 72 and positioned for insertion into the pin cavity 72 as the pin 22 carrying end cap 20 is assembled into the housing 12. The pin contacting portion 70 can additionally and/or alternatively be secured within the pin cavity 72 by methods known to those skilled in the art, such as soldering. Other configurations of a pin contacting portion 70 and a pin 22 can also be used. For example, a cavity could be defined by the pin contacting portion 70, with a part of the pin 22 configured for insertion into the cavity. Alternatively, a spring force could hold the pin contacting portion 70 in electrically conductive contact with the pin 22, and/or the pin contacting portion 70 could be soldered to the pin 22.

In an alternative aspect of an input power conducting portion 66, the input power conducting portion 70 can include a fixture contacting portion 70′ configured for direct physical and electrical connection to a standard fluorescent light fixture. In this aspect, the fixture contacting portion 70′ can fully or partially form the electrical connector 18, for example by forming one or more electrically conductive pins 22.

Once secured, power can be conveyed from a fixture to the input power conducting portion 66. With both the power supply circuit board contacting portion 64 and the input power conducting portion 66 secured, the fixture and the power supply circuitry are electrically coupled through the contact element 60, such that an input power can be supplied to the power supply circuitry. The power supply circuitry and the LED circuit can be electrically coupled through the contact element 44, such that a power usable by the LEDs 34 can be supplied to the LED circuit and the included LEDs 34 from the power supply circuitry. Alternatively, the LED circuit could be included with and electrically coupled to the power supply circuitry in a single circuit board.

As explained below, the electrical connector headers 40 and 42 can further include optional features generally useful for controlling the alignment, positioning and orientation of the respective contact elements 44 and 60 in relation to the illustrated electrical assemblies of the LED-based light 10. It will be understood that these and other disclosed features offer advantages with respect to automated assembly of the LED-based light 10. In particular, the features of the of the electrical connector headers 40 and 42 allow for automation equipment to present the respective contact elements 44 and 60 to the electrical assemblies of the LED-based light 10 (e.g., the electrical connector 18, the LED circuit board 30 and the power supply circuit board 32 in the illustrated example) in a predictable and consistent manner for installation.

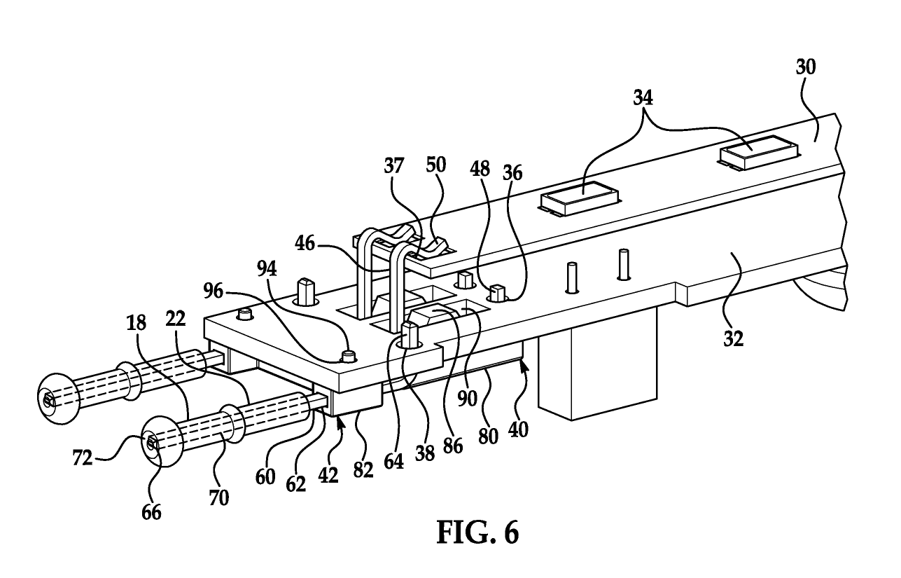

As illustrated in FIG. 4, the circuit connector header 40 can include a body 80 retentively supporting the first and second terminal ends of the contact element 44, illustrated as the pair of circuit connecting leads 46, in respective predetermined positions. As shown with additional reference to FIG. 6, the body 80 can be composed of an electrically insulative material, such as a plastic material. The body 80 may, for example, be injection molded over the intermediate portions 52 of the circuit connecting leads 46, with the power supply circuit board contacting portion 48 and the LED circuit board contacting portion 50 each projecting from the body 80. The body 80 can have a flat surface 84, and the power supply circuit board contacting portion 48, illustrated at a first terminal end of the lead 46, can project normally from the surface 84 and be configured for engagement with the through-hole conditioned power output pad 36 of the power supply circuit board 32. Similarly, LED circuit board contacting portion 50, illustrated at a second terminal end of the lead 46, can project normally from the surface 84 and be configured for engagement with the surface mount conditioned power receiving pad 37 of the LED circuit board 30. Optionally, the body 80 may include projections 86 extending normally from the surface 84 and configured for insertion into respective slot apertures 90 defined by the power supply circuit board 32 to restrict lateral movement of the circuit connector header 40. As shown, the surface 84 of the body 80 can be substantially flat and configured for abutting engagement with a portion of the power supply circuit board 32, for instance, a portion of the power supply circuit board bordering the through-hole conditioned power output pad 36 and/or the slot apertures 90.

In addition, the illustrated circuit connecting leads 46 of the circuit connector header 40 can be composed of a material configured to substantially maintain its shape during assembly of the circuit connector header 40 into the LED-based light 10. For example, the circuit connecting leads 46 can be composed of a material that is firm relative to an ordinary wire, such as a rigid, stiff or resilient material. Alternatively, only a portion of the circuit connecting leads 46 could be composed of a rigid, stiff or resilient material, for example, all or some of the portions of the circuit connecting leads 46 projecting from the body 80.

Referring now to FIG. 5, the pin connector header 42 can similarly include a body 82 retentively supporting the first and second ends of the contact element 60, illustrated as the pair of pin connecting leads 62, in predetermined positions. As shown in FIGS. 5 and 6, the body 82 can be composed of an electrically insulative material, such as a plastic material. The body 82 may, for example, be injection molded over the intermediate portions 68 of the pin connecting leads 62, with the power supply circuit board contacting portion 64 and the input power conducting portions 66 each projecting from the body 82. The power supply circuit board contacting portion 64, illustrated at a first terminal end of the lead 62, can project from the body 82 and be configured for engagement with the through-hole input power receiving pad 38 of the power supply circuit board 32. The body 82 can have a flat surface 88, and one or more post like projections 94 can project normally from the surface 88 and be configured for engagement with one or more corresponding apertures 96 defined by the power supply circuit board 32. The surface 88 of the body 82 can be substantially flat and configured for abutting engagement with a portion of the power supply circuit board 32, for instance, a portion of the power supply circuit board 32 bordering the through-hole input power receiving pad 38 and/or the apertures 96.

In addition, the illustrated pin connecting leads 62 of the pin connector header 42 can be composed of a material configured to substantially maintain its shape during assembly of the circuit connector header 42 into the LED-based light 10. For example, the pin connecting leads 62 can be composed of a material that is firm relative to an ordinary wire, such as a rigid, stiff or resilient material. Alternatively, only a portion of the pin connecting leads 62 could be composed of a rigid, stiff or resilient material, for example, all or some of the portions of the pin connecting leads 62 projecting from the body 88.

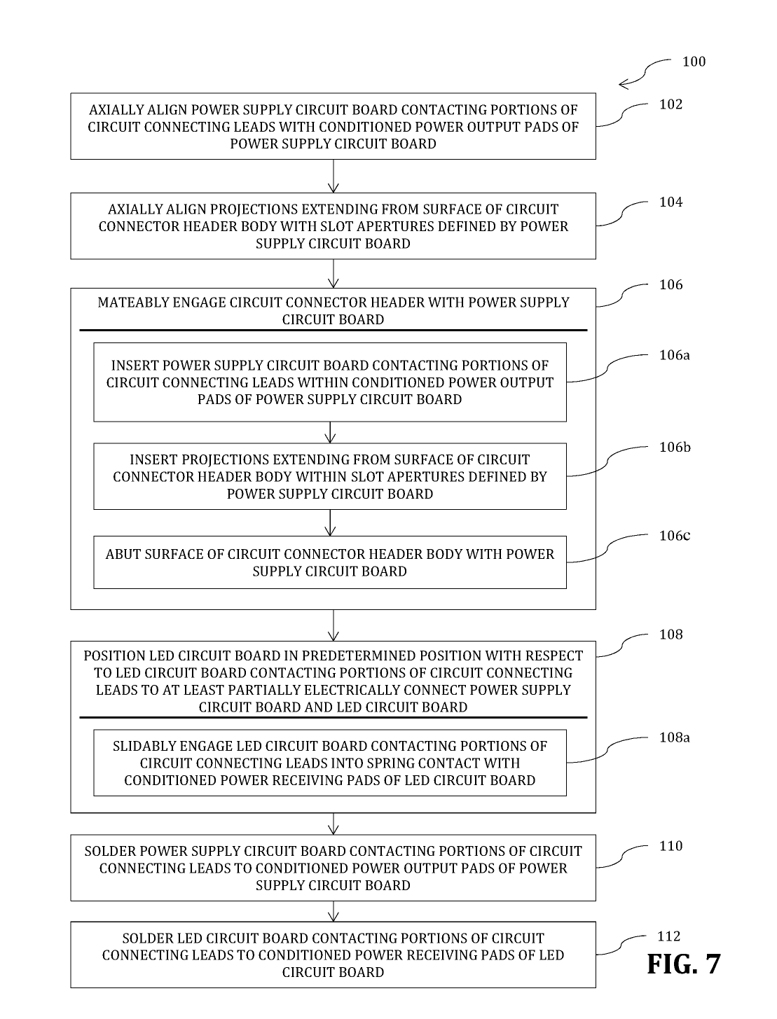

A process 100 for installing the circuit connector header 40 to electrically connect the power supply circuit board 32 and the LED circuit board 30 is shown in FIG. 7.

In operation 102, the power supply circuit board contacting portions 48 of the circuit connecting leads 46 are axially aligned with the conditioned power output pads 36 of the power supply circuit board 32. In operation 104, the projections 86 extending from the surface 84 of the body 80 of the circuit connector header 40 are axially aligned with the slot apertures 90 defined by the power supply circuit board 32.

In operation 106, the circuit connector header 40 is mateably engaged with the power supply circuit board 32 according to operations 106a-c. In operation 106a, the power supply circuit board contacting portions 48 of the circuit connecting leads 46 are inserted within the conditioned power output pads 36, and in operation 106b, the projections 86 extending from the surface 84 of the body 80 are inserted within the slot apertures 90. Operations 106a and 106b are performed until the surface 84 of the body 80 of the circuit connector header 40 abuts a surface of the power supply circuit board 32 in operation 106c.

It can be seen that the mateable engagement positions the power supply circuit board contacting portions 48 of the circuit connecting leads 46 within the conditioned power output pads 36, and effectively fixes the LED circuit board contacting portions 50 of circuit connecting leads 46 in a known position with respect to the power supply circuit board 32. It will be understood that, depending on the configuration of the circuit connector header 40, the operations 106a and 106b may be redundant in relation to fixing the position of the LED circuit board contacting portions 50 with respect to the power supply circuit board 32 by mateably engaging the circuit connector header 40 with the power supply circuit board 32, and that, optionally, one of the operations 106a or 106b could be eliminated.

Based on the fixed position of the LED circuit board contacting portions 50 of the circuit connecting leads 46 with respect to the power supply circuit board 32, as shown in operation 108, it is possible to position the LED circuit board 30 in a predetermined position with respect to the LED circuit board contacting portions 50 to at least partially electrically connect the power supply circuit board 32 and the LED circuit board 30.

In particular, according to operation 108a, the LED circuit board contacting portions 50 of the circuit connecting leads 46 may be slidably engaged into spring contact with the conditioned power receiving pads 37 of the LED circuit board 30. For instance, in the illustrated example of the circuit connector header 40, the LED circuit board contacting portions 50 are arcuate and configured for cam action with respect to a leading edge of the LED circuit board 30, such that forcible engagement of the LED circuit board 30 causes displacement of the LED circuit board contacting portions 50 that permits placement of the LED circuit board contacting portions 50 into the surface mounted conditioned power receiving pads 37 of the LED circuit board 30. Return displacement of the LED circuit board contacting portions 50 following placement of the LED circuit board contacting portions 50 into the conditioned power receiving pads 37 in turn creates spring contact between the LED circuit board contacting portions 50 into the conditioned power receiving pads 37. It will be understood that the LED circuit board contacting portions 50 of the circuit connecting leads 46 and/or the conditioned power receiving pads 37 of the LED circuit board 30 may be otherwise sized and shaped with suitable complementary configurations in furtherance of creating an electrical connection between the power supply circuit board 32 and LED circuit board 30.

The slidable engagement between the LED circuit board contacting portions 50 of the circuit connecting leads 46 and the conditioned power receiving pads 37 of the LED circuit board 30 may be aided by the configuration of the LED-based light 10. In one non-limiting example, or instance, it is contemplated that the LED circuit board 30 may be fixed within the housing 12 at the position shown in FIG. 3 prior to or contemporaneously with operations 102 through 106, and that the power supply circuit board 32, with the circuit connector header 40 engaged, can be slid into the housing 12 to the position shown in FIG. 3 to effect the slidable engagement between the LED circuit board contacting portions 50 and the conditioned power receiving pads 37 of the LED circuit board 30.

The above described operations 102 through 108 may cause electrically conductive engagement to arise between the power supply circuit board contacting portions 48 of the circuit connecting leads 46 and the conditioned power output pads 36 of the power supply circuit board 32, and between the LED circuit board contacting portions 50 of the circuit connecting leads 46 and the conditioned power receiving pads 37 of the LED circuit board 30, sufficient for creating the electrical connection between the power supply circuit board 32 and the LED circuit board 30. In this instance, the electrical connection between the power supply circuit board 32 and LED circuit board 30 may optionally be secured according to operations 110 and 112. Alternatively, it will be understood that the operations 102 through 108 may not be sufficient for creating the electrical connection between the power supply circuit board 32 and the LED circuit board 30. In this alternative, the electrical connection partially created in operations 102 through 108 may be completed according to operations 110 and 112.

In operation 110, the power supply circuit board contacting portions 48 of the circuit connecting leads 46 are soldered to the conditioned power output pads 36 of the power supply circuit board 32. Similarly, in operation 112, the LED circuit board contacting portions 50 of the circuit connecting leads 46 are soldered to the conditioned power receiving pads 37 of the LED circuit board 30.

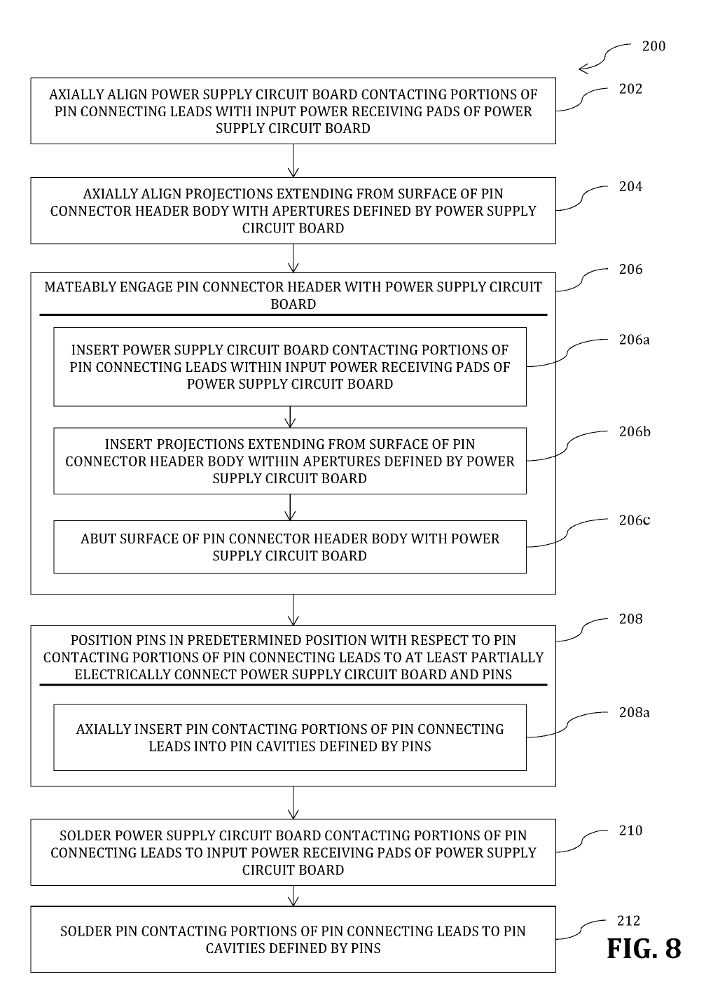

A process 200 for installing the pin connector header 42 to electrically connect the power supply circuit board 32 and the pin 22 is shown in FIG. 8.

In operation 202, the power supply circuit board contacting portions 64 of the pin connecting leads 62 are axially aligned with the input power receiving pads 38 of the power supply circuit board 32. In operation 204, the projections 94 extending from the surface 88 of the body 82 of the pin connector header 42 are axially aligned with the apertures 96 defined by the power supply circuit board 32.

In operation 206, the pin connector header 42 is mateably engaged with the power supply circuit board 32 according to operations 206a-c. In operation 206a, the power supply circuit board contacting portions 64 of the pin connecting leads 62 are inserted within the input power receiving pads 38 of the power supply circuit board 32, and in operation 206b, the projections 94 extending from the surface 88 of the body 82 are inserted within apertures 96. Operations 206a and 206b are performed until the surface 88 of the body 82 of the pin connector header 42 abuts a surface of the power supply circuit board 32 in operation 206c.

It can be seen that the mateable engagement positions the power supply circuit board contacting portions 64 of the pin connecting leads 62 within the input power receiving pads 38, and effectively fixes the pin contacting portions 70 of the pin connecting leads 62 in a known position with respect to the power supply circuit board 32. It will be understood that, depending on the configuration of the pin connector header 42, the operations 206a and 206b may be redundant in relation to fixing the position of the pin contacting portions 70 with respect to the power supply circuit board 32 by mateably engaging the pin connector header 42 with the power supply circuit board 32, and that, optionally, one of the operations 206a or 206b could be eliminated.

The mateable engagement between the pin connector header 42 and the power supply circuit board 32 can position a pin contacting portion 70′ for engagement with a fixture, as explained above. However, in the illustrated example, based on the fixed position of the pin contacting portions 70 of the pin connecting leads 62 with respect to the power supply circuit board 32, as shown in operation 208, it is possible to position the pins 22 in predetermined position with respect to the pin contacting portions 70 to at least partially electrically connect the power supply circuit board 32 and the pins 22.

In particular, according to operation 208a, the pin contacting portions 70 of the pin connecting leads 62 may be axially inserted into the pin cavities 72 defined by the pins 22. The axial insertion of the pin contacting portions 70 of the pin connecting leads 62 into the pin cavities 72 defined by the pins 22 may be aided by the configuration of the LED-based light 10. In one non-limiting example, or instance, it is contemplated that the end cap 20 carrying the pins 22 may be configured to supportively engage the power supply circuit board 32 at the position shown in FIG. 3. In this example, subsequent to operations 202 through 206, placement of the end cap 20 into supportive engagement with the power supply circuit board 32 concurrently effects the axial insertion of the pin contacting portions 70 into the pin cavities 72 defined by the pins 22.

The above described operations 202 through 208 may cause electrically conductive engagement to arise between the power supply circuit board contacting portions 64 of the pin connecting leads 62 and the input power receiving pads 38 of the power supply circuit board 32, and between the pin contacting portions 70 of the pin connecting leads 62 and the pin cavities 72 defined by the pins 22, sufficient for creating the electrical connection between the power supply circuit board 32 and the pins 22. In this instance, the electrical connection between the power supply circuit board 32 and the pins 22 may optionally be secured according to operations 210 and 212. Alternatively, it will be understood that the operations 202 through 208 may not be sufficient for creating the electrical connection between the power supply circuit board 32 and the pins 22. In this alternative, the electrical connection partially created in operations 202 through 208 may be completed according to operations 210 and 212.

In operation 210, the power supply circuit board contacting portions 64 of the pin connecting leads 62 are soldered to the input power receiving pads 38 of the power supply circuit board 32. Similarly, in operation 212, the pin contacting portions 70 of the pin connecting leads 62 are soldered to the to pin cavities 72 defined by the pins 22.

The illustrated headers 40 and/or 42 can permit electrical connections between electrical assemblies of the LED-based light 10 to be made more easily compared to landing ordinary, flexible wires between the electrical assemblies. By using the illustrated headers 40 and/or 42, the correct alignment and positioning of the contact elements 44 and 60, and in particular of the power supply circuit board contacting portion 48 and the LED circuit board contacting portion 50 of the circuit connector header 40, and of the power supply circuit board contacting portion 64 and the input power conducting portions 66 of the pin connector header 42, can be quickly achieved in a predictable and consistent manner.

In addition to eliminating the difficulty associated with landing ordinary wires to make electrical connections between the electrical assemblies of the LED-based light 10, predictable and consistent alignment and positioning can allow for automation of the process of electrically connecting the electrical assemblies. For example, with the power supply circuit board contacting potion 48 positioned within the conditioned power output pad 36, with the LED circuit board contacting portion 50 positioned in contact with the conditioned power receiving pad 37, and with the power supply circuit board contacting portion 64 positioned within the input power receiving pad 38, the respective electrical connections are at least partially completed, and can be fully completed by soldering the contacting portions to the respective pads. Alternatively, as explained above, the positioning alone could provide the necessary electrically conductive engagement for creating the electrical connections.

The LED-based lights described herein are presented as examples and are not meant to be limiting. For example, in one embodiment, an LED-based light can include the header 40 without the header 42. Conversely, in another embodiment, an LED-based light can include the header 42 without the header 40. The embodiments can be used with any lighting components known to those skilled in the art and compatible with the scope of this disclosure.

While recited characteristics and conditions of the invention have been described in connection with certain embodiments, it is to be understood that the invention is not to be limited to the disclosed embodiments but, on the contrary, is intended to cover various modifications and equivalent arrangements included within the spirit and scope of the appended claims, which scope is to be accorded the broadest interpretation so as to encompass all such modifications and equivalent structures as is permitted under the law.

What is claimed is:

1. An LED-based light configured for replacing a conventional fluorescent light in a fluorescent light fixture, comprising:
an LED circuit board including at least one LED;
a power supply circuit board configured to supply power to the at least one LED;
an end cap carrying at least one pin configured for connection to the fixture;
a pin connector header, the pin connector header including a first body retentively supporting at least one pin connecting lead and configured to engage the power supply circuit board such that the pin connecting lead is positioned to electrically connect the power supply circuit board and the pin; and
a circuit connector header, the circuit connector header including a second body retentively supporting at least one circuit connecting lead and configured to engage the power supply circuit board such that the circuit connecting lead is positioned to electrically connect the power supply circuit board and the LED circuit board.

2. The LED-based light of claim 1, wherein:
the first body retentively supports the at least one pin connecting lead such that a power supply circuit board contacting portion and a pin contacting portion of the pin connecting lead project from the first body; and
the power supply circuit board contacting portion of the pin connecting lead is positioned within an input power receiving pad of the power supply circuit board and the pin contacting portion is inserted within a cavity defined by the pin.

3. The LED-based light of claim 2, wherein the pin contacting portion of the pin connecting lead is axially inserted within the pin cavity.

4. The LED-based light of claim 2, wherein:
the power supply circuit board contacting portion of the pin connecting lead projects from the first body to extend beyond a surface of the first body; and
the engagement between the pin connector header and the power supply circuit board at least partially includes the power supply circuit board contacting portion of the pin connecting lead positioned within the input power receiving pad of the power supply circuit board and the surface of the first body abutting the power supply circuit board.

5. The LED-based light of claim 1, wherein:
the second body retentively supports the at least one circuit connecting lead such that a power supply circuit board contacting portion and a LED circuit board contacting portion of the circuit connecting lead project from the second body; and
the power supply circuit board contacting portion of the circuit connecting lead is positioned within a conditioned power output pad of the power supply circuit board and the LED circuit board contacting portion is positioned within a conditioned power receiving pad of the LED circuit board.

6. The LED-based light of claim 5, wherein:
the power supply circuit board contacting portion of the circuit connecting lead projects from the second body to extend beyond a surface of the second body; and
the engagement between the circuit connector header and the power supply circuit board at least partially includes the power supply circuit board contacting portion of the circuit connecting lead positioned within the conditioned power output pad of the power supply circuit board and the surface of the second body abutting the power supply circuit board.

7. The LED-based light of claim 5, wherein the LED circuit board contacting portion of the circuit connecting lead is engaged in spring contact within the conditioned power receiving pad of the LED circuit board.

8. The LED-based light of claim 1, wherein:
the first body includes a projection extending beyond a surface of the first body; and
the engagement between the pin connector header and the power supply circuit board at least partially includes the projection positioned within an aperture defined by the power supply circuit board and the surface of the body abutting the power supply circuit board.

9. The LED-based light of claim 1, wherein:
the second body includes a projection extending beyond a surface of the second body; and
the engagement between the circuit connector header and the power supply circuit board at least partially includes the projection positioned within an aperture defined by the power supply circuit board and the surface of the body abutting the power supply circuit board.

10. The LED-based light of claim 1, further comprising:
a housing, wherein the LED circuit board, the power supply circuit board and the pin are spatially distributed with respect to one another within the housing.

11. An LED-based light configured for replacing a conventional fluorescent light in a fluorescent light fixture, comprising:
an LED circuit board including at least one LED;
a power supply circuit board configured to supply power to the at least one LED;
an end cap carrying at least one pin configured for connection to the fixture; and
a connector header, the connector header including a body retentively supporting at least one lead having a first contacting portion and a second contacting portion and configured to engage the power supply circuit board such that the first contacting portion of the lead is positioned within a pad of the power supply circuit board and the second contacting portion of the lead is positioned within one of:
a pad of the LED circuit board to electrically connect the power supply circuit board and the LED circuit board, and
a pin cavity defined by the pin to electrically connect the power supply circuit board and the pin.

12. The LED-based light of claim 11, wherein the second contacting portion of the lead is engaged in spring contact within the pad of the LED circuit board.

13. The LED-based light of claim 11, wherein the second contacting portion of the lead is axially inserted within the pin cavity.

14. The LED-based light of claim 11, wherein:
the first contacting portion projects from the body to extend beyond a surface of the body; and
the engagement between the power supply circuit board and the connector header at least partially includes the first contacting portion positioned within the pad of the power supply circuit board and the surface of the body abutting the power supply circuit.

15. The LED-based light of claim 11, wherein
the connector header includes a projection extending beyond a surface of the body; and
the engagement between the power supply circuit board and the connector header at least partially includes the projection positioned within an aperture defined by the power supply circuit board and the surface of the body abutting the power supply circuit board.

16. The LED-based light of claim 11, further comprising:
a housing, wherein the LED circuit board, the power supply circuit board and the pin are spatially distributed with respect to one another within the housing.

17. A method of assembling components of an LED-based light configured for replacing a conventional fluorescent light in a fluorescent light fixture, the components including at least an LED circuit board including at least one LED, a power supply circuit board configured to supply power to the at least one LED and an end cap carrying at least one pin configured for connection to the fixture, comprising:
engaging the power supply circuit board with a connector header including a body retentively supporting at least one lead and having a first contacting portion and a second contacting portion, wherein the engagement positions the first portion within a pad of the power supply circuit board and arranges the second contacting portion at a predetermined position; and
positioning one of the LED circuit board and the pin based on the predetermined position of the second contacting portion.

18. The method of claim 17, further comprising:
electrically connecting the power supply circuit board to the one of the LED circuit board and the pin.

19. The method of claim 17, wherein positioning comprises axially aligning the second contacting portion with a pin cavity defined by the pin and inserting the second contacting portion within the pin cavity.

20. The method of claim 17, wherein positioning comprises slidably engaging the second contacting portion into spring contact with a pad of the LED circuit board.

21. The method of claim 17, wherein:
the contacting portion projects from the body to extend beyond a surface of the body; and
engaging the power supply circuit board with the connector header comprises inserting the first contacting portion within the pad of the power supply circuit board and abutting the surface of the body with the power supply circuit board.

22. The method of claim 17, wherein:
the connector header includes a projection extending beyond a surface of the body; and
engaging the power supply circuit board with the connector header comprises inserting the projection within an aperture defined by the power supply circuit board and abutting the surface of the body with the power supply circuit board.
